(19) United States
(12) Patent Application Publication
(10) Pub. No.: US 2026/0071822 A1
(43) Pub. Date: Mar. 12, 2026

(54) SYSTEM FOR RECOVERING WASTE HEAT FROM FLUE GAS

(71) Applicant: ZHOUSHAN INSTITUTE OF CALIBRATION AND TESTING FOR QUALITY AND TECHNOLOGY SUPERVISION, Zhoushan (CN)

(72) Inventors: Huadong HAO, Zhoushan (CN); Junxue CHEN, Zhoushan (CN); Peilu SHEN, Zhoushan (CN); Haolei SHI, Zhoushan (CN); Xianlei CHEN, Zhoushan (CN); Hengcong TAO, Zhoushan (CN); Hua XIN, Zhoushan (CN); Kun ZHANG, Zhoushan (CN); Huan LIU, Zhoushan (CN)

(21) Appl. No.: 19/378,401

(22) Filed: Nov. 4, 2025

Related U.S. Application Data
(63) Continuation of application No. PCT/CN2025/132084, filed on Nov. 3, 2025.

(30) Foreign Application Priority Data
May 14, 2025 (CN) 202510617372.7

(51) Int. Cl. F27D 17/17; F28F 19/02

(52) U.S. Cl. CPC F27D 17/17; F28F 19/02

(57) ABSTRACT

A flue gas waste heat recovery system includes a heat-exchange device arranged at a flue gas outlet of a fresh feed heater, a first heating plate, a second heating plate and a control unit. A heat-collection assembly is arranged in the heat-exchange device, and is provided with a water inlet pipe and a water outlet pipe. A temperature sensor is arranged in the water outlet pipe. The first heating plate communicates with the inlet and outlet pipes via a first pipeline loop, and is sleeved outside a buffer tank. An internal chamber of the second heating plate communicates with the inlet and outlet pipes via a second pipeline loop, and is sleeved outside an air inlet pipe of the fresh feed heater. The control unit is configured to control operation of the first and second pipeline loops based on a detected value of the temperature sensor.

### CROSS-REFERENCE TO RELATED APPLICATIONS

This application is a continuation of International Patent Application No. PCT/CN2025/132084, filed on Nov. 3, 2025, which claims the benefit of priority from Chinese Patent Application No. 202510617372.7, field on May 14, 2025. The content of the aforementioned application, including any intervening amendments thereto, is incorporated by reference in its entirety.

### TECHNICAL FIELD

This application relates to petrochemical technologies, and more particularly to a system for recovering waste heat from flue gas emitted from a slurry bed heater.

### BACKGROUND

A slurry-bed residue hydrogeneration unit uses vacuum residue from atmospheric and vacuum distillation units as feedstock, which undergoes hydrocracking and hydrofining reactions under the action of a molybdenum-based catalyst. Specifically, the thermal cracking induces the breakage of carbon-carbon bonds, and then the catalyst promotes the hydrogenation of free radicals, mitigates the coke formation, and facilitates desulfurization, denitrogenation and deoxygenation reactions. Simultaneously, impurities, such as halogens and metals, are removed. Various valuable products, including desulfurized fuel gas, liquefied petroleum gas (LPG), naphtha, diesel, wax oil, and oil residue, are harvested.

Heater is a crucial auxiliary component in a slurry-bed reactor system, which plays a role in preheating the fresh feedstock entering the reactor to an appropriate temperature. As a consequence, the efficiency and selectivity of chemical reactions and the energy utilization throughout the entire production process are enhanced.

The heater typically preheats the fresh feedstock via direct heating, where flames from fuel (such as natural gas and light oil) combustion directly heat the reactor walls, thereby transferring heat to the reaction materials inside. However, the generated high-temperature flue gas is usually directly discharged to the atmosphere. To achieve the waste heat recovery, a system for recovering waste heat from flue gas is proposed herein.

### SUMMARY

The present disclosure provides a system for recovering waste heat from flue gas emitted from a slurry-bed heater to address the problem in the prior art that it fails to effectively recover and utilize the high-temperature flue gas from a heater.

In a first aspect, the present disclosure provides a system for recovering waste heat from flue gas, comprising:
a heat-exchange device;
a first heating plate;
a second heating plate; and
a control unit;
wherein the heat-exchange device is arranged at a flue gas outlet of a fresh feed heater of a processing unit for processing ethylene tar through slurry-bed hydrogeneration;
the heat-exchange device is internally provided with a flue-gas passage;
a heat-collection assembly is arranged in the flue-gas passage; the heat-collection assembly is provided with a water inlet pipe and a water outlet pipe; the water inlet pipe and the water outlet pipe communicate with a circulation medium flow channel inside the heat-collection assembly; and a temperature sensor is arranged in the water outlet pipe;
the first heating plate has an internal chamber, and the internal chamber of the first heating plate communicates with the water inlet pipe and the water outlet pipe via a first pipeline loop; and the first heating plate is sleeved outside a buffer tank of the processing unit;
the second heating plate has an internal chamber, and the internal chamber of the second heating plate communicates with the water inlet pipe and the water outlet pipe via a second pipeline loop; and the second heating plate is sleeved on an air inlet pipe of the fresh feed heater; and
the control unit is connected to the first pipeline loop, the second pipeline loop and the temperature sensor; and the control unit is configured to control operation of the first pipeline loop and the second pipeline loop based on a detected value of the temperature sensor.

The waste heat is recovered from the high-temperature flue gas via the above design to preheat the air for combustion and improve combustion efficiency, thereby decreasing fuel consumption. The waste heat is introduced into the buffer tank to form a dual-preheating mechanism, which not only improves the feed temperature, but also reduces the heater load. In other words, the control unit is configured to close the first pipeline loop and open the second pipeline loop in response to a case that the detected value of the temperature sensor is less than a preset threshold; and the control unit is also configured to open the first pipeline loop and close the second pipeline loop in response to a case that the detected value of the temperature sensor is greater than the preset threshold. In this case, the waste heat recovered from the high-temperature flue gas merely preheats the air for combustion in response to a case that the detected value of the temperature sensor is less than a preset threshold; the recovered waste heat preheats both the buffer tank and the air for combustion in response to a case that the detected value of the temperature sensor is greater than the preset threshold. Consequently, the control unit is configured to control operation of the first pipeline loop and the second pipeline loop to adapt to different scenarios.

In some embodiments, the first pipeline loop comprises a first pipe, a second pipe, a solenoid valve and a circulation pump;
a first end of the first pipe is connected with the water outlet pipe, and a second end of the first pipe is connected with an inlet of the first heating plate, and the solenoid valve is provided at the first pipe; and
a first end of the second pipe is connected with an outlet of the first heating plate, and a second end of the second pipe is connected with the water inlet pipe, and the circulation pump is provided at the second pipe.

In some embodiments, the second pipeline loop comprises a first pipe, a second pipe, a solenoid valve and a circulation pump;
a first end of the first pipe is connected with the water outlet pipe, and a second end of the first pipe is connected with an inlet of the second heating plate; and the solenoid valve is provided at the first pipe; and
a first end of the second pipe is connected with an outlet of the second heating plate, and a second end of the second pipe is connected with the water inlet pipe; and the circulation pump is provided at the second pipe.

In some embodiments, the heat-exchange device further comprises at least one cylindrical part, and the heat-collection assembly is arranged inside the at least one cylindrical part;
the heat-collection assembly comprises a first ring and a second ring arranged spaced apart along a vertical direction; and the first ring is connected to the second ring via a plurality of inclined rods;
an internal cavity of the first ring, an internal cavity of the second ring and an internal cavity of each of the plurality of inclined rods are in communication with each other;
an outer diameter of the first ring is smaller than that of the second ring; and
the second ring is connected with the water inlet pipe, and the first ring is connected with the water outlet pipe.

The above design depends on the principle of thermal expansion and contraction of the circulation medium. Specifically, after the cold circulation medium enters the second ring via the water inlet pipe, it is heated to produce high pressure, and rises to the first ring, and is discharged via the water outlet pipe, thereby reducing the load on the first and second circulation pump. Moreover, since the high-temperature flue gas passes through the plurality of inclined rods in the above structure design, the subsequent maintenance and cleaning will be simplified after the long-term soot deposition.

In some embodiments, a plurality of cylindrical parts are provided, and are connected in series; and each of the plurality of cylindrical parts is provided with the heat-collection assembly.

In some embodiments, a cross section of the internal cavity of each of the plurality of inclined rods is configured to decrease from bottom to top along a length direction of each of the plurality of inclined rods.

In some embodiments, the first ring, the second ring and the plurality of inclined rods are made of a copper material; and exterior surfaces of the first ring, the second ring and the plurality of inclined rods are coated with a corrosion-resistant coating.

In some embodiments, the plurality of inclined rods are arranged in an annular array with a center of the second ring as a center; and a metal mesh is provided between any two adjacent inclined rods among the plurality of inclined rods.

In some embodiments, the first heating plate is configured as a cylindrical structure; an inner wall of the first heating plate is configured to fit an outer side of the buffer tank, and an outer wall of the first heating plate is provided with a first thermal insulation layer; and
the second heating plate is configured as a cylindrical structure; an inner wall of the second heating plate is configured to fit an outer side of the air inlet pipe of the fresh feed heater, and an outer wall of the second heating plate is provided with a second thermal insulation layer.

In some embodiments, the control unit is configured to close the first pipeline loop and open the second pipeline loop in response to a case that the detected value of the temperature sensor is less than a preset threshold; and
the control unit is also configured to open the first pipeline loop and close the second pipeline loop in response to a case that the detected value of the temperature sensor is greater than the preset threshold.

The beneficial effects of the technical solutions in the present disclosure are described as follows.

The present disclosure provides the system for recovering waste heat from flue gas, comprising the heat-exchange device arranged at the flue gas outlet of the fresh feed heater, the first heating plate, the second heating plate and the control unit. The heat-collection assembly is arranged in the heat-exchange device, and is provided with the water inlet pipe and the water outlet pipe. The temperature sensor is arranged in the water outlet pipe. The first heating plate communicates with the inlet and outlet pipes via the first pipeline loop, and is sleeved outside the buffer tank. The internal chamber of the second heating plate communicates with the inlet and outlet pipes via the second pipeline loop, and is sleeved outside the air inlet pipe of the fresh feed heater. The control unit is configured to control operation of the first and second pipeline loops based on a detected value of the temperature sensor. The waste heat is recovered from the high-temperature flue gas via the above design to preheat the air for combustion and improve combustion efficiency, thereby decreasing fuel consumption. The waste heat is introduced into the buffer tank to form a dual-preheating mechanism, which not only improves the feed temperature, but also reduces the heater load.

### BRIEF DESCRIPTION OF THE DRAWINGS

FIG. 1 schematically shows a connection between a flue gas waste heat recovery system according to an embodiment of the present disclosure and a processing unit for processing ethylene tar by adopting slurry-bed hydrogenation;

FIG. 2 schematically shows a heat-exchange device according to an embodiment of the present disclosure;

FIG. 3 schematically shows a connection between a heat-collection assembly and a cylindrical part according to an embodiment of the present disclosure;

FIG. 4 schematically shows the heat-collection assembly according to an embodiment of the present disclosure; and

FIG. 5 schematically shows the heat-collection assembly with a metal mesh according to an embodiment of the present disclosure.

In the figures: 1—fresh feed heater; 2—heat-collection assembly; 200—first ring; 201—second ring; 202—inclined rod; 3—water inlet pipe; 4—water outlet pipe; 5—first heating plate; 6—fresh feed buffer tank; 7—second heating plate; 8—first pipe; 9—second pipe; 10—first solenoid valve; 11—first circulation pump; 12—third pipe; 13—fourth pipe; 14—second solenoid valve; 15—second circulation pump; and 16—cylindrical part.

### DETAILED DESCRIPTION OF EMBODIMENTS

To make the objects, technical solutions and advantages of the present disclosure clearer, the embodiments of the present disclosure will be described clearly and completely below in combination with the accompanying figures in the embodiments of the present disclosure.

Regarding the ethylene tar processing unit adopted herein, reference can be made to the relevant description in Chinese patent No. 221319891U. The process flow includes the following aspects. Vacuum residue from the atmospheric and vacuum distillation units is mixed with vacuum residue and catalytic slurry from a storage tank before entering a buffer tank of the processing unit. The feedstock is withdrawn through a fresh feed pump, preheated through E-1001, E-1002, and E-1003 in sequence, and heated to 342° C. via a fresh feed heater before entering a mixed feed buffer tank, where it is mixed with a fresh catalyst precursor and vacuum column bottom recycle oil. The mixed feedstock from the mixed feed buffer tank is pressurized through a reaction material feed pump and then sent to the reactor.

Provided herein E-1001, E-1002, and E-1003 are multi-stage heat exchangers arranged in series. These multi-stage heat exchangers utilize the overhead gas from the pre-flash column, the heavy vacuum gas oil (HVGO) reflux, and the intermediate reflux of the pre-flash column as heat sources, respectively, to stepwise preheat the feedstock.

The present disclosure provides a system for recovering waste heat from flue gas emitted from a slurry-bed heater to address the problem in the prior art that it fails to effectively recovery and utilize the high-temperature flue gas from a heater.

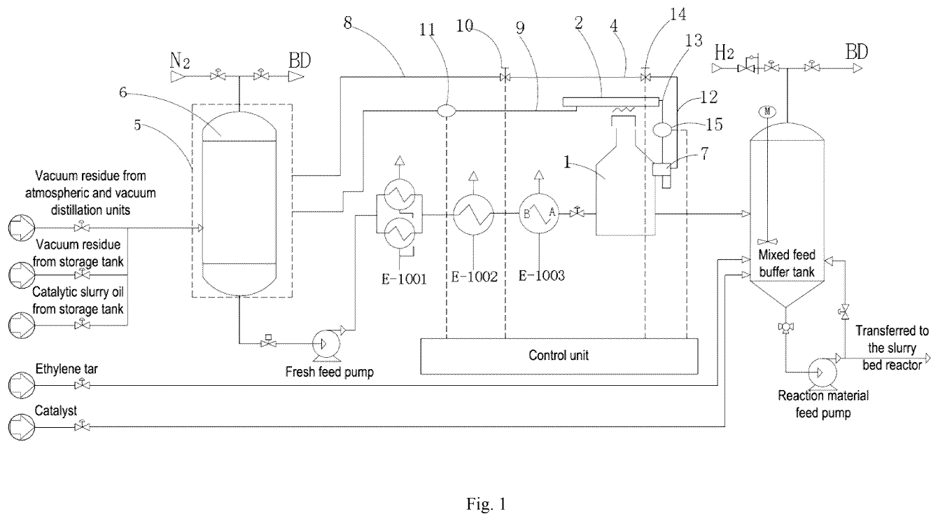

Referring to FIG. 1, a system for recovering waste heat from flue gas includes a heat-exchange device, a first heating plate, a second heating plate and a control unit.

The heat-exchange device is arranged at a flue gas outlet of a fresh feed heater 1 of a processing unit for processing ethylene tar through slurry-bed hydrogeneration. The heat-exchange device is internally provided with a flue-gas passage. A heat-collection assembly 2 is arranged in the flue-gas passage, where the heat-collection assembly 2 is provided with a water inlet pipe 3 and a water outlet pipe 4. The water inlet pipe 3 and the water outlet pipe 4 are communicate with a circulation medium flow channel inside the heat-collection assembly 2. A temperature sensor is arranged in the water outlet pipe 4.

The first heating plate 5 has an internal chamber, and the internal chamber of the first heating plate 5 communicates with the water inlet pipe 3 and the water outlet pipe 4 via a first pipeline loop. The first heating plate 5 is sleeved outside a buffer tank 6 of the processing unit.

The second heating plate 7 has an internal chamber, and the internal chamber of the second heating plate 7 communicates with the water inlet pipe 3 and the water outlet pipe 4 via a second pipeline loop. The second heating plate 7 is sleeved on an air inlet pipe of the fresh feed heater 1.

The control unit is connected to the first pipeline loop, the second pipeline loop and the temperature sensor, and the control unit is configured to control operation of the first pipeline loop and the second pipeline loop based on a detected value of the temperature sensor.

The waste heat is recovered from the high-temperature flue gas via the above design to preheat the air for combustion and improve combustion efficiency, thereby decreasing fuel consumption. The waste heat is introduced into the buffer tank 6 to form a dual-preheating mechanism, which not only improves the feed temperature, but also reduces the heater load.

In other words, the control unit is configured to close the first pipeline loop and open the second pipeline loop, when the detected value of the temperature sensor is less than a preset threshold. The control unit is configured to open the first pipeline loop and close the second pipeline loop, when the detected value of the temperature sensor is greater than the preset threshold.

In this case, the waste heat recovered from the high-temperature flue gas merely preheats the air for combustion, when the detected value of the temperature sensor is less than a preset threshold. The waste heat recovered from the high-temperature flue gas preheats both the buffer tank 6 and the air for combustion, when the detected value of the temperature sensor is greater than the preset threshold. Consequently, the control unit is configured to control operation of the first pipeline loop and the second pipeline loop to adapt to different scenarios.

In some preferable embodiments, a relationship between the control unit, the first pipeline loop, and the second pipeline loop is further illustrated as follows.

The first pipeline loop includes a first pipe 8, a second pipe 9, a first solenoid valve 10 and a first circulation pump 11.

A first end of the first pipe 8 is connected with the water outlet pipe 4. A second end of the first pipe 8 is connected with an inlet of the first heating plate 5. The first solenoid valve 10 is provided at the first pipe 8.

A first end of the second pipe 9 is connected with an outlet of the first heating plate 5. A second end of the second pipe 9 is connected with the water inlet pipe 3. The first circulation pump 11 is provided at the second pipe 9.

The second pipeline loop includes a third pipe 12, a fourth pipe 13, a second solenoid valve 14 and a second circulation pump 15.

A first end of the third pipe 12 is connected with the water outlet pipe 4. A second end of the third pipe 12 is connected with an inlet of the second heating plate 7. The second solenoid valve 14 is provided at the third pipe 12.

A first end of the fourth pipe 13 is connected with an outlet of the second heating plate 7. A second end of the fourth pipe 13 is connected with the water inlet pipe 3. The second circulation pump 15 is provided at the fourth pipe 13.

The control unit is connected with the first solenoid valve 10, the first circulation pump 11, the second solenoid valve 14 and the second circulation pump 15 through power lines and control lines. The first solenoid valve 10 is configured to open and close the first pipeline loop, and the second solenoid valve 14 is configured to open and close the second pipeline loop. The first circulation pump 11 and the second circulation pump 15 are configured to expedite a heat-exchange process.

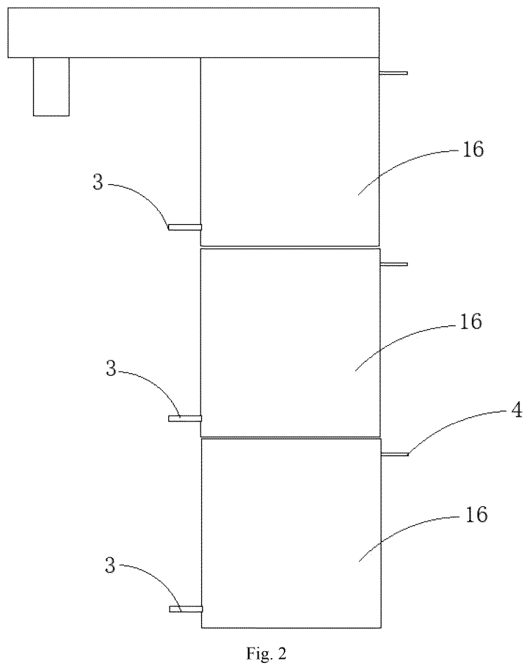

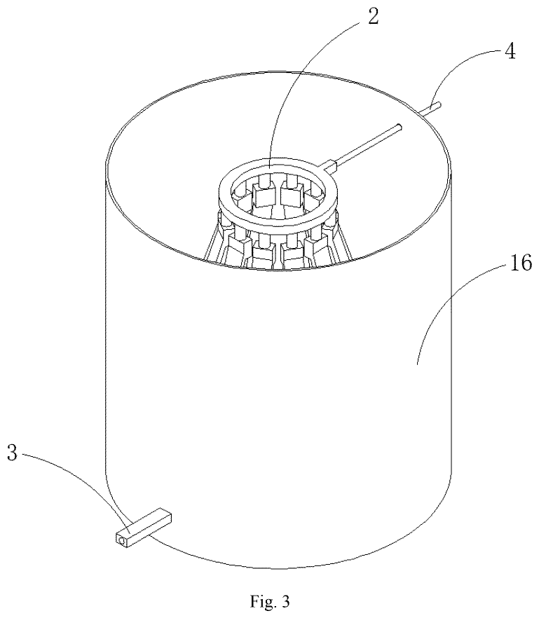

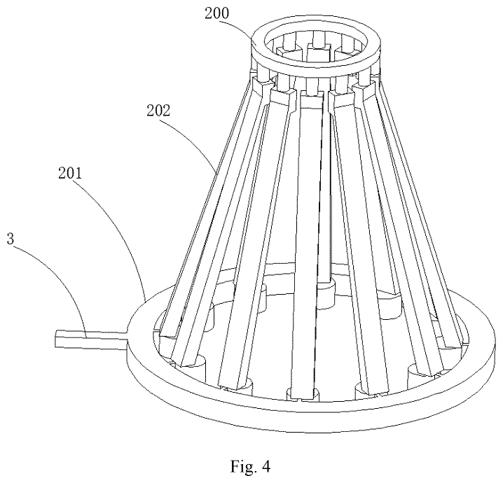

Referring to FIGS. 2-5, in some preferable embodiments, a structure of the heat-collection assembly 2 is described detailly as follows.

The heat-exchange device includes at least one cylindrical part 16, and the heat-collection assembly 2 is arranged inside the at least one cylindrical part 16.

The heat-collection assembly 2 includes a first ring 200 and a second ring 201 arranged spaced apart along a vertical direction. The first ring 200 is connected to the second ring 201 via a plurality of inclined rods 202.

An internal cavity of the first ring 200, an internal cavity of the second ring 201 and an internal cavity of each of the plurality of inclined rods 202 are in communication with each other.

An outer diameter of the first ring 200 is smaller than that of the second ring 201.

The second ring 201 is connected with the water inlet pipe 3, and the first ring 200 is connected with the water outlet pipe 4.

The above design depends on the principle of thermal expansion and contraction of the circulation medium. Specifically, after the cold circulation medium enters the second ring 201 via the water inlet pipe 3, it is heated to produce high pressure, and rises to the first ring 200, and is discharged via the water outlet pipe 4, thereby reducing the load on the first circulation pump 11 and the second circulation pump 15. Moreover, since the high-temperature flue gas passes through the plurality of inclined rods 202 in the above structure design, the subsequent maintenance and cleaning will be simplified after the long-term soot deposition.

In some embodiments, a plurality of cylindrical parts 16 are provided, and are connected in series to fully recover the waste heat from the high-temperature flue gas, and each of the plurality of cylindrical parts 16 is provided with the heat-collection assembly 2, thereby prolonging the contact time between high-temperature flue gas and the heat-exchange device to increase the heat-exchange time.

In some embodiments, a cross section of the internal cavity of each of the plurality of inclined rods 202 is configured to decrease from bottom to top along a length direction of each of the plurality of inclined rods 202, thereby significantly strengthening the principle of thermal expansion and contraction. The narrower the cross section of the internal cavity of each of the plurality of inclined rods 202 is as it goes up, the more pressure it will increase, which is convenient for the heated circulation medium to be ejected from a top of each of the plurality of the inclined rods 202.

In some embodiments, the first ring 200, the second ring 201 and the inclined rods 202 are made of a copper material, and exterior surfaces of the first ring 200, the second ring 201 and the inclined rods 202 are coated with a corrosion-resistant coating.

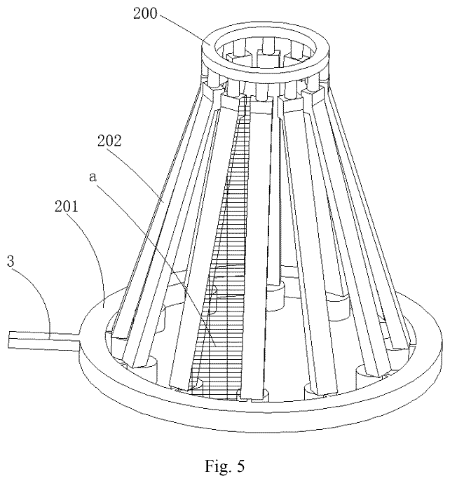

In some embodiments, the plurality of inclined rods 202 are arranged in an annular array with a center of the second ring 201 as center. A metal mesh is provided between any two adjacent inclined rods 202 among the plurality of inclined rods. This structure increases the contact area with the high-temperature flue gas to enhance the heat-exchange efficiency. The metal mesh is marked as a in FIG. 5.

In some preferable embodiments, the first heating plate 5 is configured as a cylindrical structure. An inner wall of the first heating plate 5 is configured to fit an outer side of the buffer tank 6, and an outer wall of the first heating plate 5 is provided with a first thermal insulation layer.

The second heating plate 7 is configured as a cylindrical structure. An inner wall of the second heating plate 7 is configured to fit an outer side of the air inlet pipe of the fresh feed heater 1, and an outer wall of the second heating plate 7 is provided with a second thermal insulation layer. The above design facilitates the heat-exchange process.

The beneficial effects of the present disclosure are described as follows.

In a first aspect, the waste heat is recovered from the high-temperature flue gas via the above design to preheat the air for combustion and improve combustion efficiency, thereby decreasing fuel consumption. The waste heat is introduced into the buffer tank 6 to form a dual-preheating mechanism, which not only improves the feed temperature, but also reduces the heater load.

In other words, the control unit is configured to close the first pipeline loop and open the second pipeline loop, when the detected value of the temperature sensor is less than a preset threshold. The control unit is configured to open the first pipeline loop and close the second pipeline loop, when the detected value of the temperature sensor is greater than the preset threshold.

In this case, the waste heat recovered from the high-temperature flue gas merely preheats the air for combustion, when the detected value of the temperature sensor is less than a preset threshold. The recovered waste heat preheats both the buffer tank 6 and the air for combustion, when the detected value of the temperature sensor is greater than the preset threshold. Consequently, the control unit is configured to control operation of the first pipeline loop and the second pipeline loop to adapt to different scenarios.

In a second aspect, the heat-exchange device includes at least one cylindrical part 16, and the heat-collection assembly 2 is arranged inside the at least one cylindrical part 16.

The heat-collection assembly 2 includes a first ring 200 and a second ring 201 arranged spaced apart along a vertical direction. The first ring 200 is connected to the second ring 201 via a plurality of inclined rods 202.

An internal cavity of the first ring 200, an internal cavity of the second ring 201 and an internal cavity of each of the plurality of inclined rods 202 are in communication with each other.

The second ring 201 is connected with the water inlet pipe 3, and the first ring 200 is connected with the water outlet pipe 4.

The above design depends on the principle of thermal expansion and contraction of the circulation medium. Specifically, after the cold circulation medium enters the second ring 201 via the water inlet pipe 3, it is heated to produce high pressure, and rises to the first ring 200, and is discharged via the water outlet pipe 4, thereby reducing the load on the first circulation pump 11 and the second circulation pump 15. Moreover, since the high-temperature flue gas passes through the plurality of inclined rods 202 in the above structure design, the subsequent maintenance and cleaning will be simplified after the long-term soot deposition.

What is claimed is:

1. A system for recovering waste heat from flue gas, comprising:
a heat-exchange device;
a first heating plate;
a second heating plate; and
a control unit;
wherein the heat-exchange device is arranged at a flue gas outlet of a fresh feed heater of a processing unit for processing ethylene tar through slurry-bed hydrogeneration;
the heat-exchange device is internally provided with a flue-gas passage;
a heat-collection assembly is arranged in the flue-gas passage; the heat-collection assembly is provided with a water inlet pipe and a water outlet pipe; the water inlet pipe and the water outlet pipe communicate with a circulation medium flow channel inside the heat-collection assembly; and a temperature sensor is arranged in the water outlet pipe;
the first heating plate has an internal chamber, and the internal chamber of the first heating plate communicates with the water inlet pipe and the water outlet pipe via a first pipeline loop; and the first heating plate is sleeved outside a buffer tank of the processing unit;
the second heating plate has an internal chamber, and the internal chamber of the second heating plate communicates with the water inlet pipe and the water outlet pipe via a second pipeline loop; and the second heating plate is sleeved on an air inlet pipe of the fresh feed heater; and
the control unit is connected to the first pipeline loop, the second pipeline loop and the temperature sensor; and the control unit is configured to control operation of the first pipeline loop and the second pipeline loop based on a detected value of the temperature sensor.

2. The system of claim 1, wherein the first pipeline loop comprises a first pipe, a second pipe, a solenoid valve and a circulation pump;
a first end of the first pipe is connected with the water outlet pipe, and a second end of the first pipe is connected with an inlet of the first heating plate; and the solenoid valve is provided at the first pipe; and
a first end of the second pipe is connected with an outlet of the first heating plate, and a second end of the second pipe is connected with the water inlet pipe; and the circulation pump is provided at the second pipe.

3. The system of claim 1, wherein the second pipeline loop comprises a first pipe, a second pipe, a solenoid valve and a circulation pump;
a first end of the first pipe is connected with the water outlet pipe, and a second end of the first pipe is connected with an inlet of the second heating plate; and the solenoid valve is provided at the first pipe; and
a first end of the second pipe is connected with an outlet of the second heating plate, and a second end of the second pipe is connected with the water inlet pipe; and the circulation pump is provided at the second pipe.

4. The system of claim 1, wherein the heat-exchange device further comprises at least one cylindrical part, and the heat-collection assembly is arranged inside the at least one cylindrical part;
the heat-collection assembly comprises a first ring and a second ring arranged spaced apart along a vertical direction; and the first ring is connected to the second ring via a plurality of inclined rods;
an internal cavity of the first ring, an internal cavity of the second ring and an internal cavity of each of the plurality of inclined rods are in communication with each other;
an outer diameter of the first ring is smaller than that of the second ring; and
the second ring is connected with the water inlet pipe, and the first ring is connected with the water outlet pipe.

5. The system of claim 4, wherein a plurality of cylindrical parts are provided, and are connected in series; and each of the plurality of cylindrical parts is provided with the heat-collection assembly.

6. The system of claim 4, wherein a cross section of the internal cavity of each of the plurality of inclined rods is configured to decrease from bottom to top along a length direction of each of the plurality of inclined rods.

7. The system of claim 4, wherein the first ring, the second ring and the plurality of inclined rods are made of a copper material; and exterior surfaces of the first ring, the second ring and the plurality of inclined rods are coated with a corrosion-resistant coating.

8. The system of claim 4, wherein the plurality of inclined rods are arranged in an annular array with a center of the second ring as center; and a metal mesh is provided between any two adjacent inclined rods among the plurality of inclined rods.

9. The system of claim 1, wherein the first heating plate is configured as a cylindrical structure; an inner wall of the first heating plate is configured to fit an outer side of the buffer tank, and an outer wall of the first heating plate is provided with a first thermal insulation layer; and
the second heating plate is configured as a cylindrical structure; an inner wall of the second heating plate is configured to fit an outer side of the air inlet pipe of the fresh feed heater, and an outer wall of the second heating plate is provided with a second thermal insulation layer.

10. The system of claim 1, wherein the control unit is configured to close the first pipeline loop and open the second pipeline loop in response to a case that the detected value of the temperature sensor is less than a preset threshold; and
the control unit is also configured to open the first pipeline loop and close the second pipeline loop in response to a case that the detected value of the temperature sensor is greater than the preset threshold.
